(19) United States
(12) Patent Application Publication
(10) Pub. No.: US 2007/0061545 A1
(43) Pub. Date: Mar. 15, 2007

(54) Method for writing memory sectors in a memory deletable by blocks

(75) Inventor: Reinhard Kuhne, Reichenau (DE)

Correspondence Address: BROWDY AND NEIMARK, P.L.L.C.;624 NINTH STREET, NW, SUITE 300, WASHINGTON, DC, 20001-5303, US

(73) Assignee: HYPERSTONE AG, Konstanz (DE)

(21) Appl. No.: 10/576,680

(22) PCT Filed: Aug. 31, 2004
(86) PCT No.: PCT/EP04/51975

§ 371 Date: Apr. 21, 2006

(30) Foreign Application Priority Data
Oct. 24, 2003 (DE) 10349595.9

(51) Int. Cl. G06F 12/00

(52) U.S. Cl. 711/202

(57) ABSTRACT

The invention relates to a method for writing memory sectors in individually-deletable memory blocks (SB), comprising a number of memory sectors, whereby access to the physical sectors is achieved by means of an allocation table (ZT) for address conversion of a logical address (LA) into a physical block address (RBA) and a physical sector address (RSA) and whereby, when a sector write command is to be carried out, which relates to an already written sector, the writing takes place to an alternative memory block (AB), by means of an altered address conversion, said writing processes for sectors in the alternative memory block (AB) being carried out sequentially and the position of the relevant sector in the alternative block (AB) is stored in a sector table.

The invention relates to a method for writing memory sectors in individually-deletable memory blocks, comprising a number of memory sectors, whereby access to the physical sectors is achieved by means of an allocation table for address conversion of a logical address into a physical block address and a physical sector address, and whereby when a sector write command is to be carried out, which relates to an already written sector, the writing takes place to an alternative memory block by means of an altered address conversion.

The widely used non volatile semiconductor memory (flash memory) are organized in blocks and these are again organized in sectors, whereby a block consists e.g. of 256 sectors with 512 bytes each. It is characteristic for this type of memory that new information can only be written per sector, to sectors that have been deleted before. The deletion, in each case, is carried out for all sectors of one block at a time. Writing a sector to the memory takes longer than reading it and a deletion operation of a block requires a long time, e.g. several milliseconds.

The patent application DE 102 27 256.5 describes a method for searching an alternative block to write a sector, and writing the new information to its sectors. A bit list, operating as a sector mask, notes which sectors were newly written to the respective alternative block. If a sector needs to be written to for a second time, a new alternative block is searched for and written to. It is a disadvantage of this method, that even after only a few writing procedures to one alternative block a new alternative block has to be searched for and sectors have to be copied to another location.

Furthermore, newer memory chips possess the characteristic that the sectors within a block can only be written to in a sequentially ascending manner. Thus, if non-successive sectors are to be written to, also a new alternative block must be searched for and sectors already written to have to be copied. The copying processes are relatively slow writing procedures, which impair the speed of the memory system. From the U.S. Pat. No. 5,835,935 it is known to use the next free sector in a block in each case to use for writing requirements. Thus the blocks are sequentially written to, but in each case the table of allocation between the logical and the physical sector address is adapted, each adaptation requiring a further writing procedure.

It is the object of the invention to reveal a method that avoids the described disadvantages and improves the speed of the memory system.

This object is met in such a way that the writing processes for sectors in the alternative memory block are carried out sequentially and the position of the relevant sector in the alternative block is stored in the sector table.

Advantageous embodiments of the invention are presented in the subclaims.

When writing a sector, it is addressed by a logical address. This address can be split up into a logical sector address and a logical block address. The memory system is organized as physical memory blocks, which can be deleted as a whole, and in physical sectors, which can be written to individually. The logical block addresses are assigned to physical memory block addresses in an allocation table. The logical sector addresses are used directly as physical sector addresses, without an address conversion. Some memory blocks are reserved as alternative blocks, which can be used in the writing operations. An alternative block is assigned to the respective memory block which is to be written to, and the addresses of the alternative blocks and the corresponding lists, indicating which sectors have been written, are kept in the internal indicator memory of the memory controller which is part of the memory system. Hence it is favourable to sequentially write the changed sectors of a block to the corresponding alternative block, and to organize the list as a sector table, indicating to which sector of the alternative block the respective memory sector was written.

In one execution of the invention the sector table is organized as an index table, which is accessed with the physical sector address (which equals the logical sector address). The respective table entry at this position indicates the sector in the alternative block, to which the corresponding memory sector was written.

At the beginning the index table is initialized with the highest possible values (FF). Such a value indicates that the corresponding sector is still located unchanged in the original memory block.

In another execution of the sector table it is organized as a search table, indicating in each table entry the physical sector address with the respective valid sector position in the alternative block. Thereby it is favourable to organize the search table according to physical sector addresses in order to quickly find the current position of a memory sector.

In both executions of the sector table it is favourable to also store the position of the sector in the alternative block in the administration of the sector. Thus, when the memory system is restarted, the sector table can again be reconstructed from the sector positions stored in the administrative part in the indicator memory of the memory controller. During such a restart the highest item number of the corresponding sector is then transferred to the sector table.

In the execution of the method, a typical number of sectors for a memory block is 256 sectors. If executed with an index table, the latter would 256 byte. If executed with a search table, this table would then have a length of 32 byte.

In an execution in which the table has 32 bytes, the sector mask for 256 sectors can be overlaid with a search table for 16 sectors.

The corresponding sector table is filled by a number of writing operations to an alternative block. As soon as the end of the sector table is reached, a new alternative block is searched for, to which the valid sectors from the original memory block together with those from the previous alternative block are copied. Afterwards this block takes the place of the original memory block, as the entry in the allocation table is updated accordingly. The previous memory blocks and alternative blocks are cleared for deletion and, after deletion, serve as new alternative blocks.

In order to establish the most favourable write administration for the respective memory block, strategy indicator is carried along for each logical block address in the allocation table. This indicator shows, whether the last writing operations was carried out with a bit-by-bit sector mask or with a byte-by-byte sector table. This type of administration for the alternative block is also maintained for the next writing operations. Favourably, the strategy indicators are first initialised with the remark “sector mask”, since most writing operations are carried out in a purely sequential manner, in which case administration by means of a sector mask is the fastest.

However, with memory systems of the type “FAT file system” it is favourable to initialise the memory blocks, containing the FAT, immediately with the strategy indicator “sector table”, since this type of memory system carries out frequent writing operations to the same memory sectors. Thus the speed of the memory system is increased from the beginning.

If during the operation of the memory system a more frequent overwriting of individual memory sectors are is stated, it is favourable to change the administration of the alternative block from a sector mask to a sector table. Also the strategy indicator in the allocation table is then adjusted accordingly. If there are no duplicates of sectors, it is favourable to change to the sector mask for administration of the memory block.

An exemplary embodiment of the invention is described by the figures.

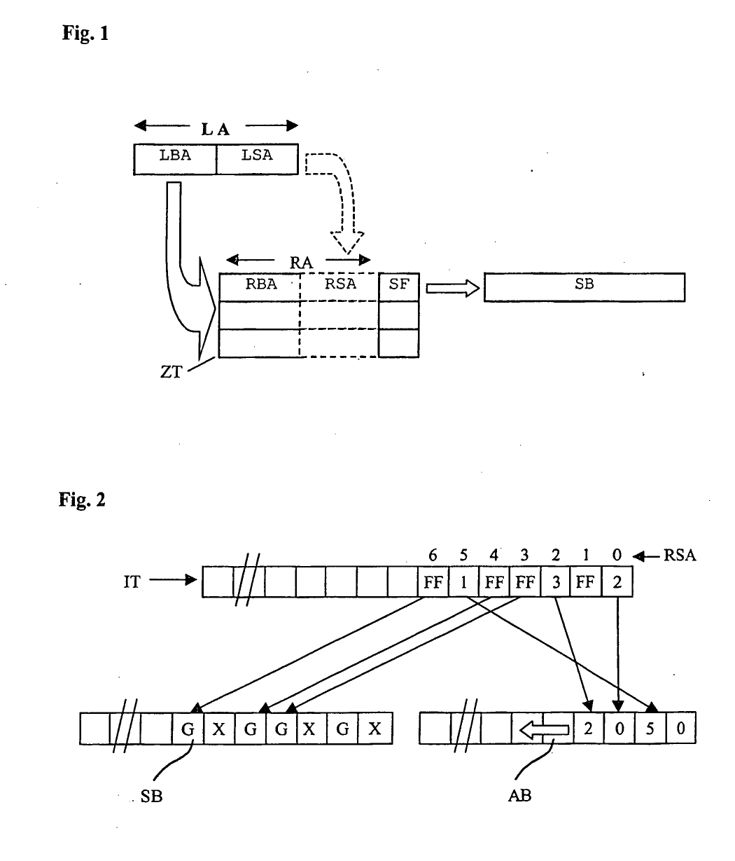

FIG. 1 shows the allocation of the memory blocks to the logical addresses

FIG. 2 shows the write administration by means of an index table

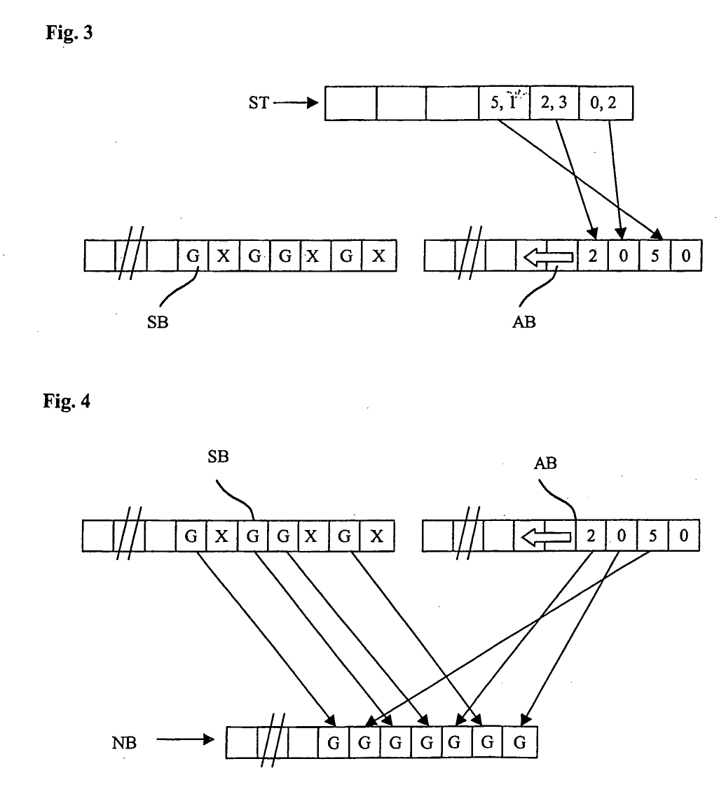

FIG. 3 shows the write administration by means of a search table

FIG. 4 shows the combination of a memory block with an alternative block, forming a new memory block

FIG. 1 represents the logical address LA, which consists of the logical block address LBA and the logical sector address LSA. The allocation table ZT, in which the corresponding physical address RA is stored, is accessed by means of the logical block address LBA. The physical address RA consists of the physical block address RBA and the physical sector address RSA. Here, the physical sector address RSA is not stored, since the logical sector address LSA is also used as the physical sector address RSA. Furthermore, the allocation table ZT stores the strategy indicator SF belonging to the respective logical block address, which indicates whether a sector mask or a sector table is used. The physical address RA belonging to a logical address LA points to a memory block SB, which is used for the storing operation with the logical address LA.

FIG. 2 shows a memory block SB and a corresponding alternative block AB, in which the memory operations are controlled by means of an index table IT. The index table IT is accessed via the physical sector address RSA. The table entry either indicates the actual position of the corresponding sector in the alternative block AB, or indicates that the appropriate sector is still valid (G) in the memory block SB. For this, a highest value (FF) is registered at the appropriate positions in the index table IT. Sectors, which are not longer valid, newer sector contents of which are located in the alternative block, are represented by (X) in the memory block SB. In the alternative block AB writing to the sectors is carried out sequentially, as indicated by the arrow. Several sector contents corresponding to a logical sector address LSA can be registered in the alternative block. In this example this concerns sector 0, which is registered at the positions 0 and 2 in the alternative block AB. The corresponding position 0 in the index table IT indicates the valid sector. In order to be able to reconstruct the table correctly at a system start, the ascending sequence of the sectors is abided by. If during the reading of the alternative block a sector is found several times, in this example sector 0, the sector with the highest position in the block is the valid sector.

In FIG. 3 the same situation as in FIG. 2 is represented, this time with a search table ST. It is organized by logical sector addresses LSA, in this case these are the sectors 0, 2, 5. For each table entry the corresponding valid sector is located in the alternative block AB. Sectors not registered in the search table ST are still in the memory block SB and are marked by G in this representation.

FIG. 4 shows the combination of a memory block SB with an alternative block AB to a new memory block NB. The changed sectors, which are registered in the alternative block AB, are copied to the corresponding sectors in the new memory block NB. The remaining sectors are copied from the original memory block SB to the new memory block NB. This block then contains only valid sectors, marked by G in this representation.

### REFERENCE SYMBOLS

AB alternative block
FF highest value
G valid sector
IT index table
LA logical address
LBA logical block address
LSA logical sector address
NB new memory block
RBA physical block address
RSA physical sector address
SB memory block
SF strategy indicator
ST search table
X invalid sector
ZT allocation table

1. Method for writing memory sectors in individually-deletable memory blocks (SB), comprising a number of memory sectors, whereby access to the physical sectors is achieved by means of an allocation table (ZT) for address conversion of a logical address (LA) into a physical block address (RBA) and a physical sector address (RSA), and whereby when a sector write command is to be carried out, which relates to an already written sector, the writing takes place to an alternative memory block (AB) by means of an altered address conversion, characterized in that the writing processes for sectors in the alternative memory block are carried out sequentially and the position of the relevant sector in the alternative block (AB) is stored in the sector table.

2. Method according to claim 1, characterized in that the altered address conversion is carried out by means of a data record with a physical block address (RBA) and a sector table in the internal storage of a memory controller.

3. Method according to claim 1, characterized in that the sector is organized as an index table (IT), wherein the physical sector address (RSA) serves as an index and the valid sector position in the alternative block (AB) is indicated at the corresponding position in the table.

4. Method according to claim 3, characterized in that a highest possible value assigned to a sector address (RSA) in the index table (IT) indicates that the corresponding sector remains unchanged in the original memory block (SB).

5. Method according to claim 1, characterized in that the sector table is organized as a search table (ST), each table entry of which indicates the physical sector address (RSA) with the corresponding valid sector position in the alternative block (AB).

6. Method according to claim 5, characterized in that the search table (ST), is sorted by physical sector addresses (RSA).

7. Method according to claim 1, characterized in that the position of the sector within the alternative block (AB) is also stored in the administrative part of the sector.

8. Method according to claim 7, characterized in that the sector table of a block is reconstructed from the sector positions stored in the administrative part when the memory system is restarted.

9. Method according to claim 8, characterized in that when restarting, the sector position with the highest item number is registered in the sector table.

10. Method according to claim 3, characterized in that a memory block contains 256 sectors and the corresponding index table (IT) has 32 byte.

11. Method according to claim 5, characterized in that a memory block contains 256 sectors and the corresponding search table (ST) has 32 byte.

12. Method according to claim 1, characterized in that, as soon as the sector table is filled, a new alternative block is searched for, to which the valid sectors from the original memory block, together with those from the previous alternative block, are then copied.

13. Method according to claim 12, characterized in that the new alternative block is registered in the allocation table as the original memory block and the previous memory- and alternative blocks are cleared for deletion.

14. Method according to claim 1, characterized in that in the allocation table a strategy indicator is carried along with each logical block address, indicating whether a sector mask or a sector table have last been used for the latter.

15. Method according to claim 14, characterized in that the strategy indicator is initialised with the remark “sector mask”.

16. Method according to claim 15, characterized in that if the memory system is formatted as a FAT file system, the memory blocks are initialised with the remark “sector table”.

17. Method according to claim 1, characterized in that if only a few sectors have been written to the alternative block system, and one of these blocks is to be rewritten, the administration of the alternative block is switched from sector mask to sector table.
